(19) United States
(12) Patent Application Publication
(10) Pub. No.: US 2023/0025195 A1
(43) Pub. Date: Jan. 26, 2023

(54) SYSTEM AND METHOD FOR DETECTING MOISTURE IN A USB TYPE-C PORT

(71) Applicant: Harman International Industries, Incorporated, Stamford, CT (US)

(72) Inventors: Robin Luo, Changpin (CN); Bo Zhong, Chengdu (CN)

(73) Assignee: Harman International Industries, Incorporated, Stamford, CT (US)

(21) Appl. No.: 17/381,902

(22) Filed: Jul. 21, 2021

(51) Int. Cl. G01V 3/02; H01R 13/66; H02J 7/00; G08B 21/20

(52) U.S. Cl. CPC G01V 3/02; H01R 13/6683; H02J 7/0029; G08B 21/20; H01R 24/60

(57) ABSTRACT

A system and method for detecting moisture in a USC Type-C port having at least one probe comprised of a signal electrode and a VBUS electrode in the USB Type-C port. The at least one probe detects a voltage at the signal electrode and a judgment circuit compares detected voltage to a voltage threshold, wherein the judgment circuit outputs a low setting when the voltage detected at the signal electrode of the at least one probe is less than or equal to the threshold voltage, and the judgment circuit outputs a high setting when the voltage detected at the signal electrode is above the voltage threshold.

### TECHNICAL FIELD

The present disclosure relates to a detecting moisture in a USB Type-C port.

### BACKGROUND

Many electronic devices, particularly portable electronic devices, are equipped with a USB Type-C port for powering and/or charging the devices. The port is susceptible to moisture seeping into it when exposed to liquid, such as from a spill. Moisture in the port may adversely affect conductivity, ultimately degrading performance of the electronic device. Unfortunately, the port may be exposed to liquid without a user's knowledge.

There is a need to detect moisture in a port and alert a user to take appropriate action to clean and dry the port before using the electronic device.

### SUMMARY

A system and method for detecting moisture in a USB Type-C port having at least one probe comprised of a signal electrode and a VBUS electrode in the USB Type-C port. The at least one probe detects a voltage at the signal electrode and a judgment circuit compares detected voltage to a voltage threshold, wherein the judgment circuit outputs a low setting when the voltage detected at the signal electrode of the at least one probe is less than or equal to the threshold voltage, and the judgment circuit outputs a high setting when the voltage detected at the signal electrode is above the voltage threshold.

### DESCRIPTION OF DRAWINGS

FIG. 1. is a diagram of a pin configuration for a USB Type-C port;

FIG. 2 is a schematic of a judgment circuit; and

FIG. 3 is a flow chart of a method of one or more embodiments.

Elements and steps in the figures are illustrated for simplicity and clarity and have not necessarily been rendered according to any sequence. For example, steps that may be performed concurrently or in different order are illustrated in the figures to help to improve understanding of embodiments of the present disclosure.

### DETAILED DESCRIPTION

While various aspects of the present disclosure are described with reference to the figures presented herein, the present disclosure is not limited to such embodiments, and additional modifications, applications, and embodiments may be implemented without departing from the present disclosure. In the figures, like reference numbers will be used to illustrate the same components. Those skilled in the art will recognize that the various components set forth herein may be altered without varying from the scope of the present disclosure.

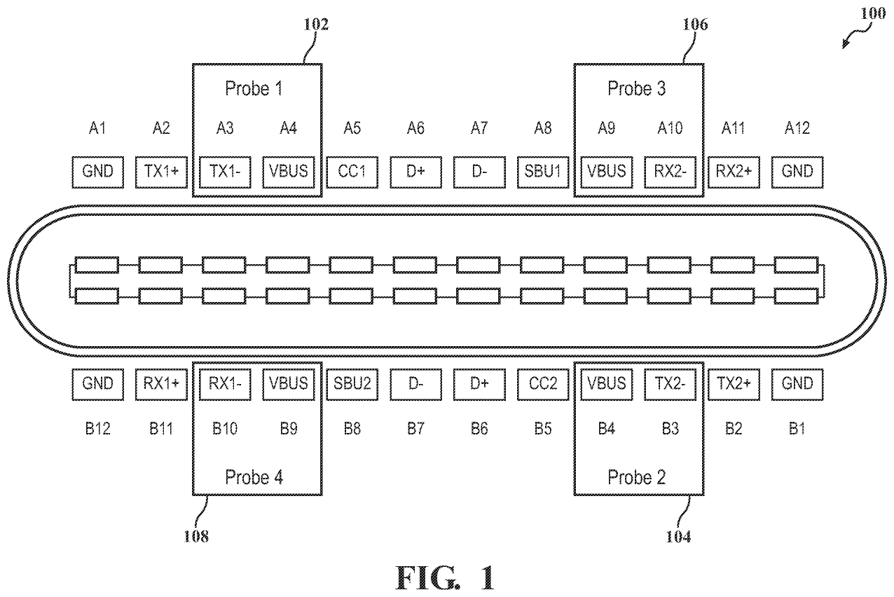

FIG. 1 is a diagram of electrode configuration for a USB Type-C port 100 having signal electrodes, VBUS electrodes, and ground electrodes. Signal electrodes that are not being used for communication are paired with VBUS electrodes to create probes that detect a change in impedance between signal and VBUS. A detected change in impedance between the probe and VBUS may be used as an indicator of moisture in the port. For example, in one or more embodiments, four probes 102, 104, 106, 108 are used to detect moisture. A first probe 102 consists of a VBUS, or power, electrode A4 and signal electrode A3. A second probe 104 consists of power electrode B4 and signal electrode B3. A third probe 106 consists of power electrode A9 and signal electrode A10. A fourth probe 108 consists of power electrode B9 and signal electrode B10. It should be noted that four probes, one at each end and side of the port, are shown in the present example, but any number of probes and combination of ground and signal electrodes of the USB Type-C port may be used to accomplish similar results.

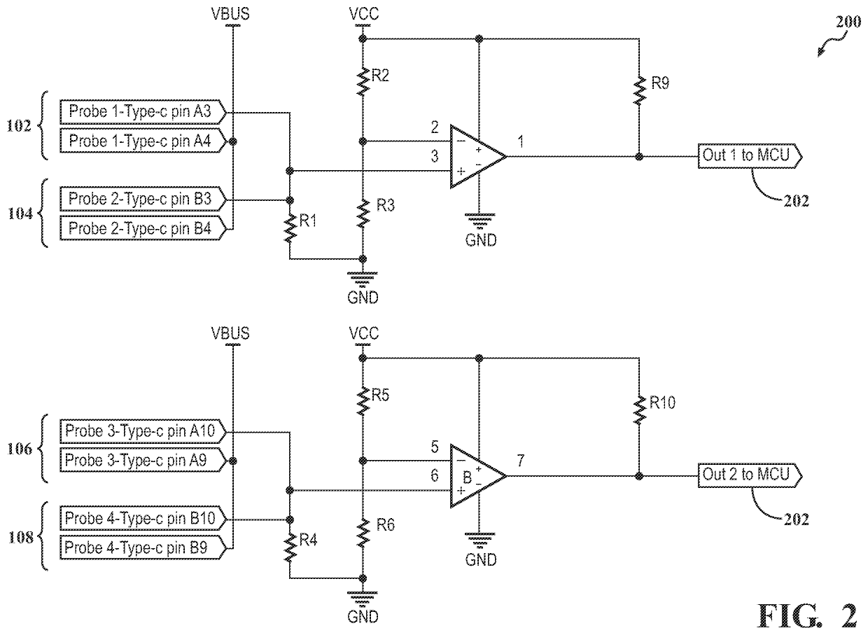

FIG. 2 is a schematic of a judgment circuit 200 that monitors the voltage at the signal electrode of each probe. Liquids, such as water, have better electrical conductivity than air and cause a rise in voltage in signal the electrodes. A rise in voltage detected by the probes is an indication that moisture is detected in the port. Therefore, when a USB Type-C connector is plugged into the port, and the port has not been exposed to moisture, the voltage at each probe remains low. The impedance between the probe and VBUS is infinity and the voltage of the signal electrode is pulled down due to R1 or R4. However, if any probe has been exposed to moisture, the voltage will rise because the impedance between the signal electrode and VBUS of the probe decreases. Detecting a change in the impedance between the signal electrode and VBUS is an indicator that the port may have been exposed to moisture.

A threshold voltage is predetermined and is the minimum voltage a signal electrode exhibits when its voltage matches an electrical conductivity of air. When a USB Type-C connector is plugged into the port, a voltage of the signal electrode at each probe is detected. If the voltage of any one of the signal electrodes is lower than the threshold voltage, the judgment circuit outputs 202 a low voltage indicator to a microcontroller on the device. If any one of the signal electrodes is higher than the threshold voltage, the judgment circuit outputs 202 a high voltage indicator to the microcontroller. When a high voltage indicator is output 202 to the microcontroller, the microcontroller may initiate actions to protect the electronic device. For example, interrupt charging, output a warning, and suggest the port be cleaned and dried.

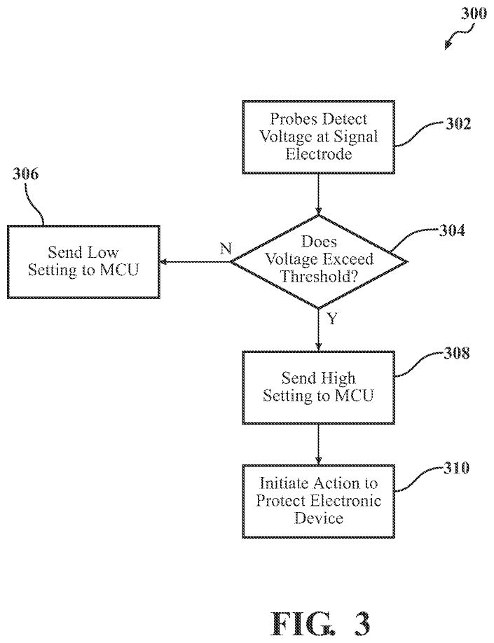

FIG. 3 is a flow chart of a method 300 for detecting moisture in a USB Type-C port. The method is carried out in one or more processors, such as a microcontroller (MCU) on an electronic device having a USB Type-C port. The one or more processors have a memory, a communication interface, and a bus. The bus includes a circuit that connects elements, such as switches, a battery, and one or more boosters. The bus transmits communication (data or control messages) between the elements. The one or more processors have a CPU to carry out operations or data processing related to the control and/or communications between the elements. Memory includes volatile and non-volatile memory to store instructions including software programs, executed by the one or more processors to control or manage the devices according to the method described herein.

In a first step 302, after a USB Type-C connector is plugged into a USB Type-C port, one or more probes detects a voltage of a signal electrode at each probe. In step 304 the voltage detected at each probe is compared to a threshold voltage.

When the voltage of the signal electrode of each the probe is lower than or equal to the threshold voltage, at step 306, a low setting is sent to the MCU. When the voltage of at least one of the probes is higher than the threshold voltage, at step 308, a high setting is sent to the MCU.

At step 310, upon receiving a high setting at the MCU, the MCU sends instructions to protect the electronic device. For example, the MCU may send instructions causing an interrupt in charging. The MCU may send instructions causing a communication that moisture has been detected in the USB Type-C port and it needs user attention. Further, the MCU may send instructions causing a communication to the user that the USB Type-C port needs to be cleaned and dried before attempting to charge or use the device. The communication may be displayed in graphic form at a display on the electronic device. It may be communicated as an audible tone or message at the electronic device. Or it may be in any other suitable form that communicates, to the user, the USB Type-C connector has been exposed to moisture and requires attention before proceeding with its use.

In the foregoing specification, the present disclosure has been described with reference to specific exemplary embodiments. The specification and figures are illustrative, rather than restrictive, and modifications are intended to be included within the scope of the present disclosure. Accordingly, the scope of the present disclosure should be determined by the claims and their legal equivalents rather than by merely the examples described.

For example, the steps recited in any method or process claims may be executed in any order, may be executed repeatedly, and are not limited to the specific order presented in the claims. Additionally, the components and/or elements recited in any apparatus claims may be assembled or otherwise operationally configured in a variety of permutations and are accordingly not limited to the specific configuration recited in the claims. Any method or process described may be carried out by executing instructions with one or more devices, such as a processor or controller, memory (including non-transitory), sensors, network interfaces, antennas, switches, actuators to name just a few examples.

Benefits, other advantages, and solutions to problems have been described above for one or more embodiments. However, any benefit, advantage, solution to problem or any element that may cause any particular benefit, advantage, or solution to occur or to become more pronounced are not to be construed as critical, required, or essential features or components of any or all the claims.

The terms “comprise”, “comprises”, “comprising”, “having”, “including”, “includes” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, or components used in the practice of the present disclosure, in addition to those not specifically recited, may be varied, or otherwise particularly adapted to specific environments, manufacturing specifications, design parameters or other operating requirements without departing from the general principles of the same.

What is claimed is:

1. A system for determining a presence of moisture in a USB Type-C port on an electronic device, comprising:
at least one probe comprised of a signal electrode and a VBUS electrode in the USB Type-C port, the at least one probe detects a voltage at the signal electrode of the at least one probe;
a judgment circuit configured to compare the voltage detected at the signal electrode to a voltage threshold;
the judgment circuit outputs a low setting when the voltage detected at the signal electrode of the at least one probe is less than or equal to the threshold voltage; and
the judgment circuit outputs a high setting when the voltage detected at the signal electrode is above the voltage threshold.

2. The system of claim 1, further comprising:
four probes, one probe being positioned at each end and side of the USB Type-C port;
the judgment circuit outputs a low setting when the voltage detected at the signal electrode for each of the probes is less than or equal to the voltage threshold; and
the judgment circuit outputs a high setting when the voltage detected at the signal electrode for any one of the probes is above the voltage threshold.

3. The system of claim 1, further comprising:
a microcontroller (MCU) electrically connected to the judgment circuit, wherein the MCU receives the judgment circuit output; and
when the high setting is received at the MCU, the MCU initiates actions to protect the electronic device.

4. The system of claim 3, wherein the MCU initiates an action to interrupt charging the electronic device.

5. The system of claim 3, wherein the MCU initiates an action to alert a user that the presence of moisture in USB Type-C port has been detected.

6. An electronic device comprising:
a USB Type-C port that receives a USB Type-C plug;
a first probe having one signal electrode of the USB Type-C port and a VBUS electrode of the USB Type-C port, the first probe detects a voltage at the signal electrode when the USB Type-C plug is inserted into the USB Type-C port; and
a judgment circuit electrically connected to the first probe, the judgment circuit outputs a low setting when the voltage detected at the signal electrode of the first probe is less than or equal to a threshold voltage, and the judgment circuit outputs a high setting when the voltage detected at the signal electrode of the first probe is greater than the threshold voltage.

7. The electronic device of claim 6, further comprising:
four probes, one probe being positioned at each end and side of the USB Type-C port;
the judgment circuit outputs a low setting when the voltage detected at the signal electrode for each of the probes is less than or equal to the threshold voltage; and
the judgment circuit outputs a high setting when the voltage detected at the signal electrode for any one of the probes is greater than the threshold voltage.

8. The electronic device of claim 6, further comprising:
a microcontroller (MCU) electrically connected to the judgment circuit, wherein the MCU receives the judgment circuit output; and
when the high setting is received at the MCU, the MCU initiates actions to protect the electronic device.

9. The electronic device of claim 8, wherein the MCU initiates an action to interrupt charging.

10. The electronic device of claim 8, wherein the MCU initiates an action to alert a user that moisture has been detected in the USB Type-C port.

11. The electronic device of claim 8, further comprising a display electrically connected to the MCU, wherein the MCU initiates an action to display a message to alert a user that moisture has been detected in the USB Type-C port.

12. The electronic device of claim 8, wherein the MCU initiates an action to display a message that moisture has been detected in the USB Type-C port and an action is required to clean and dry the USB Type-C port.

13. A method for detecting moisture in a USB Type-C port, the method comprising the steps of:
detecting a voltage of a signal electrode for at least one probe upon connecting a USB Type-C connector to the USB Type-C port;
comparing the voltage detected at the signal electrode to a threshold voltage;
when the voltage detected at the signal electrode is less than or equal to the threshold voltage, outputting a low signal;
when the voltage detected at the signal electrode is greater than the threshold voltage, outputting a high signal; and
initiating an action in response to the high signal output.

14. The method of claim 13, wherein the step of initiating an action in response to a low signal output further comprises interrupting power from the USB Type-C connector.

15. The method of claim 13, wherein the step of initiating an action in response to a low signal further comprises communicating a message that moisture has been detected in the USB Type-C port.

16. The method of claim 14, further comprising the steps of:
communicating a message that moisture has been detected in the USB Type-C port;
communicating a message that the power from the USB Type-C connector has been interrupted and should be removed from the USB Type-C port; and
communicating a message to clean and dry the USB Type-C port before reconnecting the USB Type-C connector.
